(19) United States
(12) Patent Application Publication
(10) Pub. No.: US 2013/0321468 A1
(43) Pub. Date: Dec. 5, 2013

(54) CORNER DETECTION

(71) Applicant: Bastien Nocera, Guildford (GB)

(72) Inventor: Bastien Nocera, Guildford (GB)

(73) Assignee: RED HAT, INC., Raleigh, NC (US)

(21) Appl. No.: 13/483,943

(22) Filed: May 30, 2012

(51) Int. Cl. G09G 5/14

(52) U.S. Cl. 345/651

(57) ABSTRACT

A computing device detects an orientation of a computing device and selects a corner of the computing device based on the orientation of the computing device. The computing device determines a height and width for each digital media item in a plurality of digital media items. The computing device displays a first digital media item of the plurality of digital media items in a portrait orientation when the height of the first digital media item is greater than the width of the first digital media item and displays a second digital media item of the plurality of digital media items in a landscape orientation when the width of the second digital media item is greater than the height of the second digital media item.

### TECHNICAL FIELD

Embodiments of the present disclosure relate to the field of digital media items and, more particularly, to displaying digital media items.

### BACKGROUND

Computing devices such as desktop computers, laptop computers, tablet computers, netbooks, smartphones, and personal digital assistants (PDAs) are now commonly used by various people and organizations for different purposes. Computing devices may often be mobile or portable computing devices, such as tablet computers, laptops, touch screen laptops (e.g., a laptop computer with a touch screen display), netbooks, smartphones, and personal digital assistants (PDAs). Users often use computing devices to view digital media items such as electronic books, electronic newspapers, electronic magazines, other electronic reading material, Portable Document Format (PDF) files, digital images (e.g., Joint Photographic Experts Group (JPEG) images, bitmaps (BMPs), Portable Network Graphics (PNG) images, Graphics Interchange Format (GIF) images, etc.) and digital videos (e.g., MPEG-2 files, MPEG-4 (MP4) files, DivX files, audio video interlace (AVI) files, advanced video coding (AVC) files, Flash® video files, VP8 files, etc.).

FIG. 1 illustrates presentation of data on a computing device 100 in a conventional manner. The computing device 100 may be a tablet computer, a touch screen computer, a smartphone, a touch screen device (e.g., a computing device with a touch screen), or a portable computing device. The computing device 100 includes a screen 105 (e.g., a liquid crystal display (LCD), a touch screen, etc.). A digital media item 110 (e.g., a digital image or digital video) is displayed in the screen 105. The computing device 100 and the screen 105 may be oriented or positioned in different ways when a user operates the computing device 100. For example, when a user is viewing a digital image or a digital video (e.g., a digital media item), the user may orient/position the device in a landscape orientation (e.g., an orientation where the width of the computing device 100 and/or screen 105 is larger than the height). In another example, when a user is viewing a digital media item, the user may orient/position the device in a portrait orientation (e.g., an orientation where the height of the computing device 100 and/or screen 105 is larger than the width).

The computing device 100 may use one or more sensing devices (e.g., an accelerometer, a gyroscope, a magnetometer, etc) to determine the orientation or positioning of the computing device. For example, the computing device 100 may determine that the computing device 100 is positioned/oriented in a landscape orientation, based on data received from a gyroscope or an accelerometer. In another example, the computing device 100 may determine that the computing device 100 has changed position/orientation (e.g., changed from a landscape orientation to a portrait orientation) based on data received from a gyroscope and/or an accelerometer.

Generally, once the computing device 100 has determined the orientation of the computing device 100, digital media items are displayed based on the determined orientation of the computing device 100 until the user moves and/or repositions the device (e.g., until the user rotates the device or changes the device's orientation). The digital media items may be adjusted such that the digital media items are upright (e.g., right side up) when displayed in the screen 105. As shown in FIG. 1, the computing device 100 and the screen 105 are oriented in a landscape orientation. The digital media item 110 may be better suited for display in a portrait orientation. However, because the computing device 100 is in a landscape orientation, the digital media item 110 is adjusted such that the digital media item 110 is upright when displayed on the screen 105. For example, instead of displaying the digital media item 110 rotated on its side, the digital media item 110 is adjusted such that it fits within the screen 105 when the computing device 100 is in the landscape orientation. Also as shown in FIG. 1, portions 115 and 120 of the screen 105 are unused (e.g., are not used to display the digital media item 110 or are “wasted”), due to the adjustment of the digital media item 110.

FIG. 2 illustrates presentation of data on another computing device 200 in conventional manner. The computing device 200 includes a screen 205 and a digital media item 210 is displayed in the screen 205. The computing device 200 may use one or more sensing devices (e.g., an accelerometer, a gyroscope, a magnetometer, etc) to determine the orientation or positioning of the computing device. As shown in FIG. 2, the computing device 200 and the screen 205 are oriented in a portrait orientation. The digital media item 210 may be better suited for display in a landscape orientation. However, because the computing device 200 is in a portrait orientation, the digital media item 210 is adjusted such that the digital media item 210 fits within the screen 205 and is upright when displayed on the screen 205. Also as shown in FIG. 2, portions 215 and 220 of the screen 205 are unused (e.g., are not used to display the digital media item 210 or are “wasted”), due to the adjustment of the digital media item 210.

### BRIEF DESCRIPTION OF THE DRAWINGS

The present invention is illustrated by way of example, and not by way of limitation, and can be more fully understood with reference to the following detailed description when considered in connection with the figures in which:

FIG. 1 illustrates presentation of data on a computing device in a conventional manner.

FIG. 2 illustrates presentation of data on a computing device in a conventional manner.

FIG. 3 is a block diagram illustrating a computing device according to one embodiment.

FIG. 4 is a diagram illustrating a computing device displaying a digital media item on a screen, according to one embodiment.

FIG. 5 is a diagram illustrating a computing device displaying a digital media item on a screen, according to another embodiment.

FIG. 6 is a diagram illustrating a computing device displaying a digital media item on a screen, according to a further embodiment.

FIG. 7 is a diagram illustrating a computing device displaying a digital media item on a screen, according to yet another embodiment.

FIG. 8 is a flow diagram illustrating a method for displaying digital media items, in accordance with one embodiment.

FIG. 9 is a flow diagram illustrating a method for displaying digital media items, in accordance with another embodiment.

FIG. 10 illustrates a diagrammatic representation of a machine in the exemplary form of a computer system, in accordance with one embodiment.

### DETAILED DESCRIPTION

A method and system for displaying digital media items on a computing device are described. In one embodiment, the computing device may determine the orientation/position of the computing device using one or more sensor devices. The computing device may select a corner of the computing device based on the orientation/position of the computing device. In one embodiment, the selected corner may be the corner which is closest to a user of the computing device when the user sets the computing device down on surface (e.g., when the user sets a tablet computer down on a table top) or when the user is holding the computing device.

In one embodiment, the computing device may display a plurality of digital media items (e.g., digital videos and/or digital images) after selecting a corner of the computing device based on the orientation/position of the computing device. The computing device may determine the height and width of the digital media items (e.g., determine the pixel height or pixel width of a digital image or digital video). In one embodiment, the computing device may display a digital image in a portrait orientation if the digital media item has a height greater than its width (e.g., the digital media item is more suited for display in a portrait orientation). The lower left or lower right corner/portion of the digital media item may correspond to the selected corner of the computing device. In another embodiment, the computing device may display the digital image in a landscape orientation if the digital media item has a height less than its width (e.g., the digital media item is more suited for display in a landscape orientation). The lower left or lower right corner/portion of the digital media item may also correspond to the selected corner of the computing device.

In one embodiment, orientation/position of the computing device may change after the computing device selects a corner. The computing device may select a new corner, based on the change in the orientation/position of the computing device. After selecting the new corner, the computing device may display a plurality of digital media items (e.g., digital videos and/or digital images). In one embodiment, the computing device may display the digital image in a portrait orientation if the digital media item has a height greater than its width (e.g., the digital media item is more suited for display in a portrait orientation). The lower left or lower right corner/portion of the digital media item may correspond to the new corner of the computing device. In another embodiment, the computing device may display the digital image in a landscape orientation if the digital media item has a height less than its width (e.g., the digital media item is more suited for display in a landscape orientation). The lower left or lower right corner/portion of the digital media item may also correspond to the new corner of the computing device.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

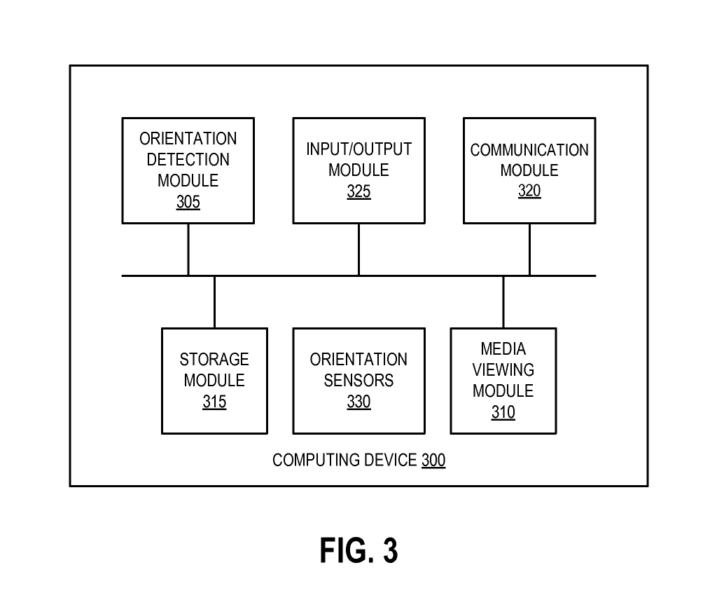

FIG. 3 is a block diagram of an exemplary computing system 300 in which embodiments of the invention may operate. The computing system 300 may be a touch screen computer, a personal digital assistant (PDA), a smart phone, a laptop computer, a netbook computer, a tablet computer, and/or any machine capable of executing a set of instructions (sequential or otherwise) that specify actions to be taken by that machine. The computing system 300 includes an orientation detection module 305, an input/output module 325, a communication module 320, a storage module 315, orientation sensors 330, and a media viewing module 310. More or less components may be included in the computing device 300 without loss of generality.

In one embodiment, the orientation sensors 330 may be one or more devices which may be used to determine the position/orientation of the computing device 300 and/or detect changes in the position/orientation of the computing device 300. For example, the orientation sensors 330 may include, but are not limited to, an accelerometer for measuring an acceleration of the user, a magnetometer for measuring a magnetic field associated with a change of orientation of the computing device 300, a gyroscope for providing a more precise determination of orientation of the computing device 300.

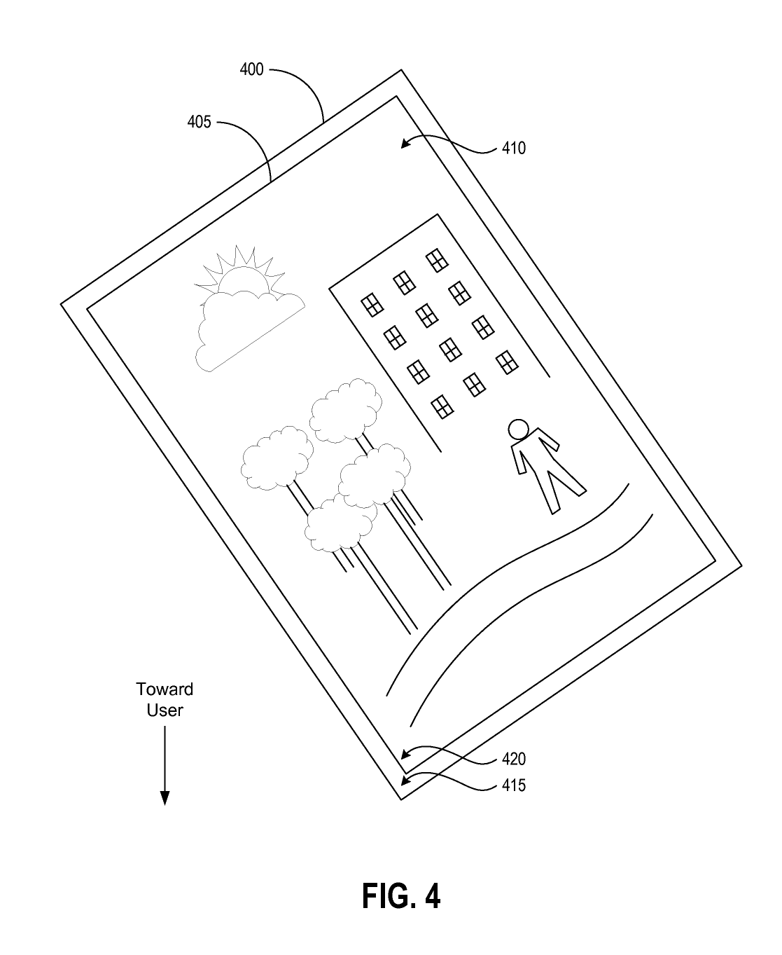

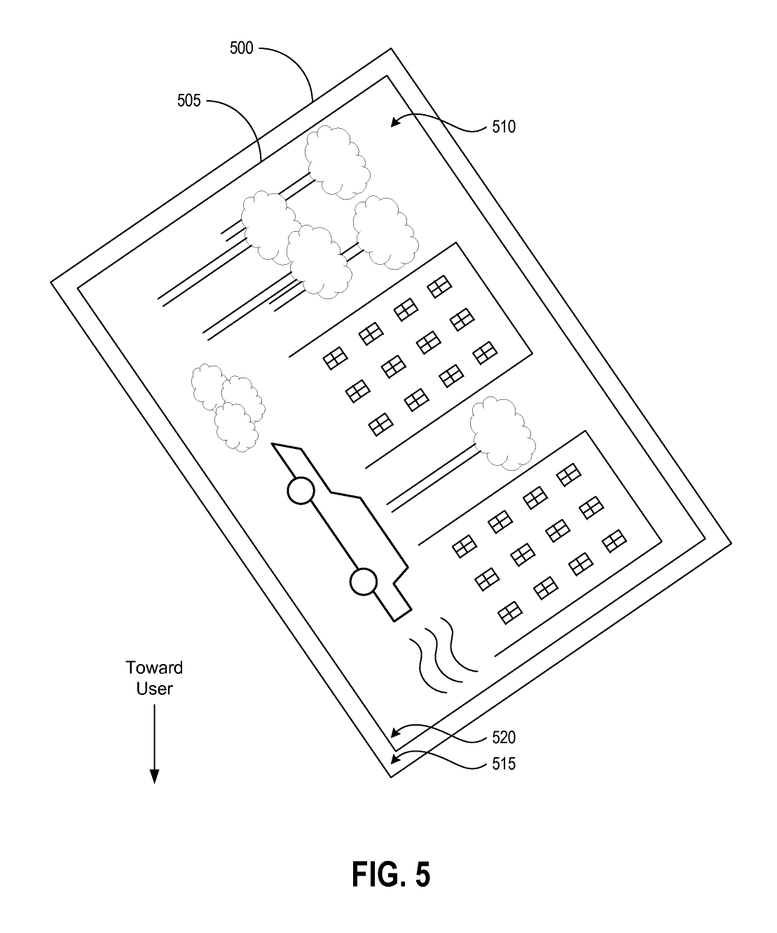

In one embodiment, the orientation detection module 305 may determine the position/orientation of the computing device 300 based on data, measurements, and/or other information received from the orientation sensors 330. For example the orientation detection module 305 may determine the orientation of the computing device 300 based on acceleration data/measurements received from an accelerometer. Based on the data received from the orientation sensors 300, the orientation detection module 305 may select a corner of the device. In one embodiment, the corner selected by the orientation detection module 305 may be a corner which is closest to a user of the computing device 300. For example, a user may hold a computing device 300 (e.g., a tablet computer) by the lower left corner of the computing device 300. The user may set or put the computing device 300 down on a surface (e.g., on a table top) such that the lower left corner of the computing device 300 is pointed towards the user (e.g., as shown below in FIGS. 4 and 5). The orientation detection module 305 may select the lower left corner after the user sets or puts the computing device 300 down on a surface.

In one embodiment, the media viewing module 310 may display one or more digital media items via the input/output module 325 (e.g., via a touch screen). The media viewing module 310 may display a digital media item in portrait orientation or landscape orientation, based on the selected corner of the computing device 300 and the width and height of the digital media item. For example, if the lower left corner of the computing device 300 is selected by the orientation detection module 305 and the height of a digital media item is greater than its width, the media view module 310 may display the digital media item in a portrait orientation such that the selected corner of the computing device corresponds to the lower left corner/portion of the digital media item. In another example, if the lower right corner of the computing device 300 is selected by the orientation detection module 305 and the height of a digital media item is less than its width, the media view module 310 may display the digital media item in a landscape orientation such that the selected corner of the computing device corresponds to the lower right corner/portion of the digital media item.

In one embodiment, the input/output module 325 may include hardware, software, and/or a combination of both. For example, the input/output module 325 may include, but is not limited to, one or more of a keyboard, a mouse, a touch pad, a touch screen, a stylus, and/or software and drivers associated with the input/output module 325. In another embodiment, the input/output module 325 may be used to accept user input (e.g., accept user input to select and/or browse through digital media items) and may also be used to display digital media items to a user (e.g., user input is received and digital media items are displayed on a touch screen).

In one embodiment, the storage module 315 may store one or more digital media items (e.g., one or more digital videos and/or digital images) which may be displayed by the media viewing module 310. The storage module 315 may be any device or medium which may store data. For example, the storage module 315 may include, but is not limited to, flash memory, a hard disk, an optical medium (e.g., a CD-ROM), random access memory (RAM), etc.

In one embodiment, the communication module 320 may be used by the computing device 300 to communicate with a network and/or other devices (e.g., other user devices, other computers such as servers, etc.). For example, the computing system 300 may download digital media items from one or more servers using the communication module 320 (and may store these digital media items in the storage module 315). The communication module 320 may be hardware, software, or a combination of both. For example, the communication module 320 may include, but is not limited to, a network interface card (NIC), a wireless or cellular network card, one or more antennae, physical cables, and/or software and drivers associated with the communication module 320.

FIG. 4 is a diagram illustrating a computing device 400 displaying a digital media item 410 on a screen 405, according to one embodiment. The computing device 400 is rotated towards the left from a portrait orientation (e.g., the computing device is in a diagonal orientation or is tilted diagonally towards the left). In one embodiment, the computing device 400 may be held in a diagonal orientation by a user. For example, the user may be holding the computing device 400 (e.g., a tablet computer, a smart phone, etc.) by the corner 415 of the computing device 400 (e.g., in order to allow another user to view the digital media item 410). In another embodiment, the user may set the computing device 400 down on a surface (e.g., a table top, a bed, a couch, etc.) in the diagonal orientation.

In one embodiment, the computing device 400 may use one or more orientation sensors (e.g., an accelerometer, a gyroscope, etc.) to determine the orientation/position of the computing device 400. The computing device 400 may also select the corner 415 of the computing device 400 based on the orientation/position of the computing device 400. For example, the computing device 400 may determine that the computing device 400 is in a diagonal orientation. Based on the diagonal orientation, the computing device 400 may select the corner 415, which may be the corner which is closest to and/or pointed towards the user. As shown in FIG. 4, the lower left corner/portion 420 of the digital media item 410 corresponds to (e.g., is associated or correlates with) the selected corner 415.

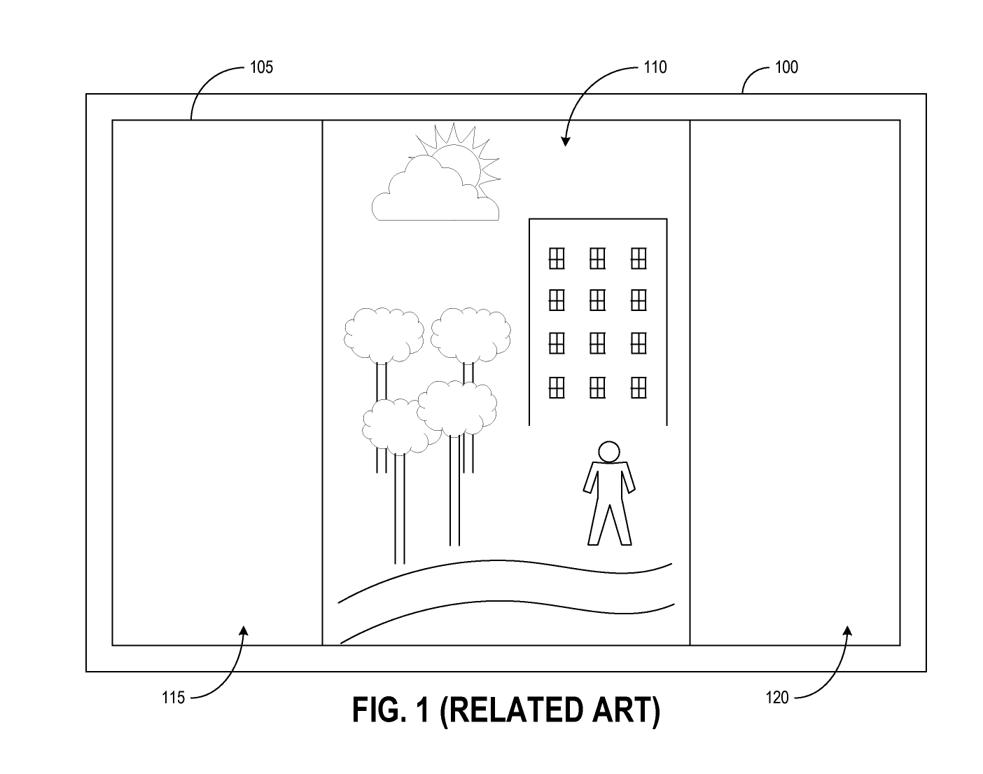

The computing device 400 displays digital media item 410 on screen 405. When the computing device 400 displays the digital media item 410, the computing device 400 may determine the height and the width of the digital media item 410. Because the height of the digital media item 410 is greater than its width, the computing device 400 may display the digital media item 410 on the screen 405, as if the computing device 400 was in a portrait orientation. In one embodiment, by displaying the digital media item 410 in a portrait orientation, the computing device 400 may maximize the use of the screen 405 when the digital media item 410 is displayed. For example, referring back to FIG. 1, the digital media item 110 is displayed on a screen 105 in a landscape orientation even though the digital media item 110 is better suited for display in a portrait orientation. Thus, the computing device 100 does not use portions 115 and 120 (e.g., wastes the portions 115 and 120, and/or does not maximize the use of the screen 105), as compared to computing device 400 which maximizes or uses a larger portion of the screen 405 to display the digital media item 410.

FIG. 5 is a diagram illustrating a computing device 500 displaying a digital media item 510 on a screen 505, according to another embodiment. Similar to computing device 400 shown in FIG. 4, the computing device 500 is rotated towards the left from a portrait orientation (e.g., a diagonal orientation). The computing device 500 may be held in the diagonal orientation by a user or the user may set the computing device 500 on a surface in the diagonal orientation.

In one embodiment, the computing device 500 may use one or more orientation sensors to detect the orientation/position of the computing device 500 and the computing device may also select the corner 515 of the computing device 500 based on the diagonal orientation/position of the computing device 500. The corner 515 may be the corner which is closest to and/or pointed towards the user. As shown in FIG. 5, the lower right corner/portion 520 of the digital media item 510 corresponds to (e.g., is associated or correlates with) the selected corner 515.

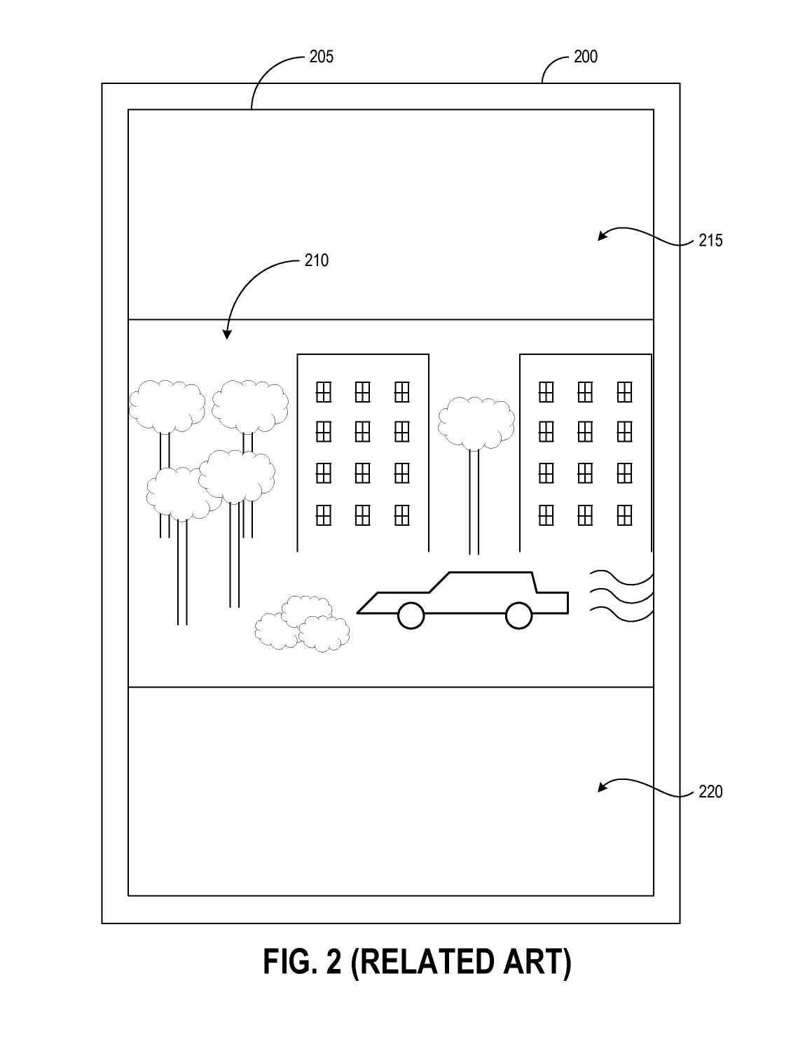

The computing device 500 displays digital media item 510 on screen 505. When the computing device 500 displays the digital media item 510, the computing device 500 may determine the height and the width of the digital media item 510. Because the height of the digital media item 510 is less than its width, the computing device 500 may display the digital media item 510 on the screen 505, as if the computing device 500 was in a landscape orientation. In one embodiment, by displaying the digital media item 510 in a landscape orientation, the computing device 500 may maximize the use of the screen 505 when the digital media item 510 is displayed. For example, referring back to FIG. 2, the digital media item 210 is displayed on a screen 205 in a portrait orientation even though the digital media item 110 is better suited for display in a landscape orientation. Thus, the computing device 200 does not use portions 215 and 220, as compared to computing device 500 which maximizes or uses a larger portion of the screen 505 to display the digital media item 510.

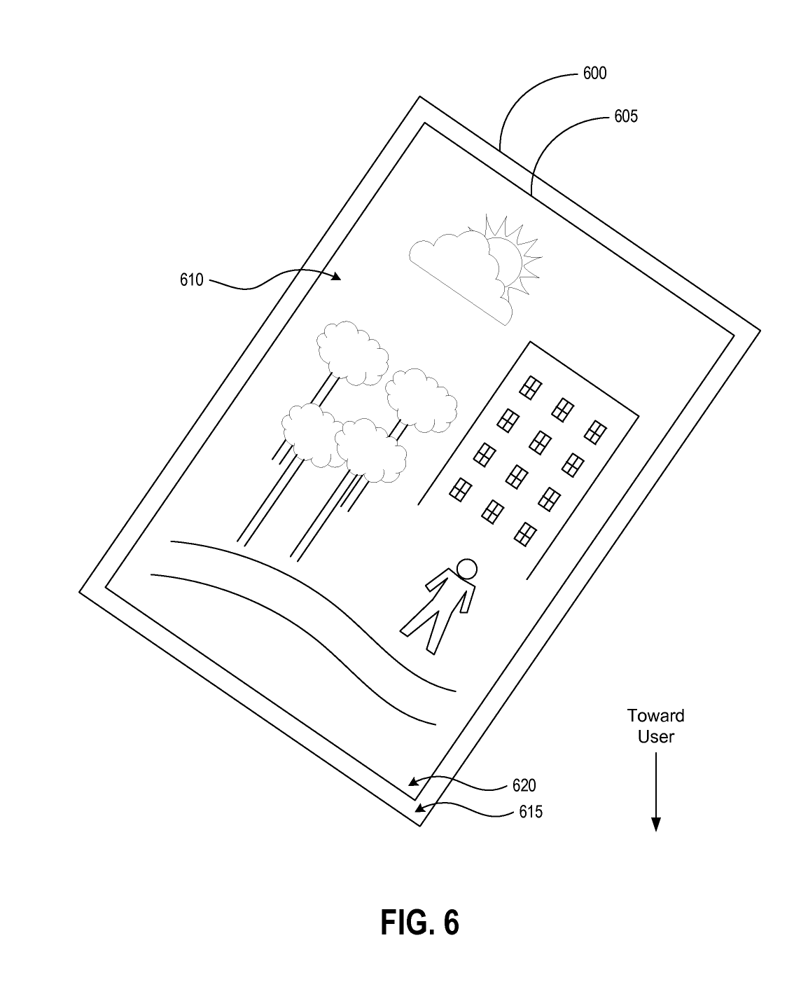

FIG. 6 is a diagram illustrating a computing device 600 displaying a digital media item 610 on a screen 605, according to one embodiment. The computing device 600 is rotated towards the right from a portrait orientation (e.g., the computing device is in a diagonal orientation or is tilted diagonally towards the right). In one embodiment, the computing device 600 may be held in a diagonal orientation by a user. In another embodiment, the user may set the computing device 600 down on a surface (e.g., a table top, a bed, a couch, etc.) in the diagonal orientation.

In one embodiment, the computing device 600 may use one or more orientation sensors to determine the orientation/position of the computing device 600 and may also select the corner 615 of the computing device 600 based on the orientation/position. Based on the diagonal orientation, the computing device 600 may select the corner 615, which may be the corner which is closest to and/or pointed towards the user. As shown in FIG. 6, the lower right corner/portion 620 of the digital media item 610 corresponds to (e.g., is associated or correlates with) the selected corner 615.

As discussed above, when the computing device 600 displays the digital media item 610, the computing device 600 may determine the height and the width of the digital media item 610. Because the height of the digital media item 610 is greater than its width, the computing device 600 may display the digital media item 610 on the screen 605, as if the computing device 600 was in a portrait orientation. In one embodiment, by displaying the digital media item 610 in a portrait orientation, the computing device 600 may maximize the use of the screen 605 when the digital media item 610 is displayed. For example, referring back to FIG. 1, the computing device 100 does not use portions 115 and 120 (e.g., wastes the portions 115 and 120, and/or does not maximize the use of the screen 105), as compared to computing device 600 which displays the digital media item 610 using a larger portion of the screen 605 (e.g., maximizing the use the screen 605).

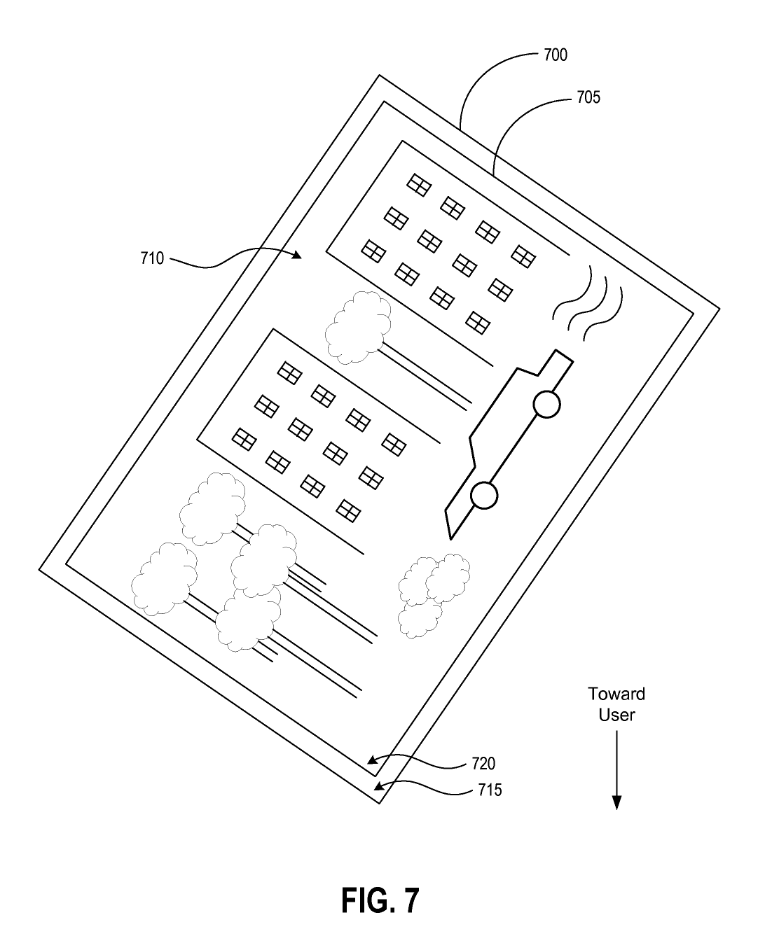

FIG. 7 is a diagram illustrating a computing device 700 displaying a digital media item 710 on a screen 705, according to another embodiment. Similar to computing device 600 shown in FIG. 6, the computing device 700 is rotated towards the right from a portrait orientation (e.g., a diagonal orientation). The computing device 700 may be held in the diagonal orientation by a user or the user may set the computing device 700 on a surface in the diagonal orientation.

In one embodiment, the computing device 700 may use one or more orientation sensors to detect the orientation/position of the computing device 700 and the computing device may also select the corner 715 of the computing device 700 based on the diagonal orientation/position of the computing device 700. The corner 715 may be the corner which is closest to and/or pointed towards the user. As shown in FIG. 7, the lower left corner/portion 720 of the digital media item 710 corresponds to (e.g., is associated or correlates with) the selected corner 715.

The computing device 700 displays digital media item 710 on screen 705. When the computing device 700 displays the digital media item 710, the computing device 700 may determine the height and the width of the digital media item 710. Because the height of the digital media item 710 is less than its width, the computing device 700 may display the digital media item 710 on the screen 705, as if the computing device 700 was in a landscape orientation. In one embodiment, by displaying the digital media item 710 in a landscape orientation, the computing device 700 may maximize the use of the screen 705 when the digital media item 710 is displayed. For example, referring back to FIG. 2, the digital media item 210 is displayed on a screen 205 in a portrait orientation even though the digital media item 110 is better suited for display in a landscape orientation. Thus, the computing device 200 does not use portions 215 and 220, as compared to computing device 700 which maximizes or uses a larger portion of the screen 705 to display the digital media item 710.

In some embodiments, as illustrated in FIGS. 4, 5, 6, and 7, a computing device the computing device may display a first digital media item as if the computing device was in a portrait orientation and display a second digital media as if the computing device was in a landscape orientation (or vice versa), without a change in the position/orientation of the computing device. For example, the computing device may display a first digital image as if the computing device was in a landscape orientation and may display a second digital image as if the computing device was in a portrait orientation, even though the computing device has not changed position/orientation.

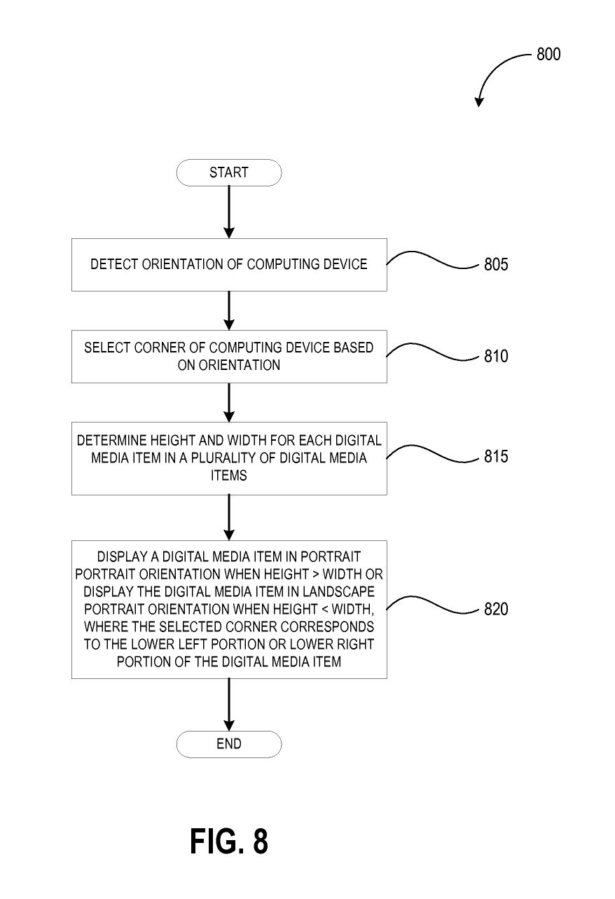

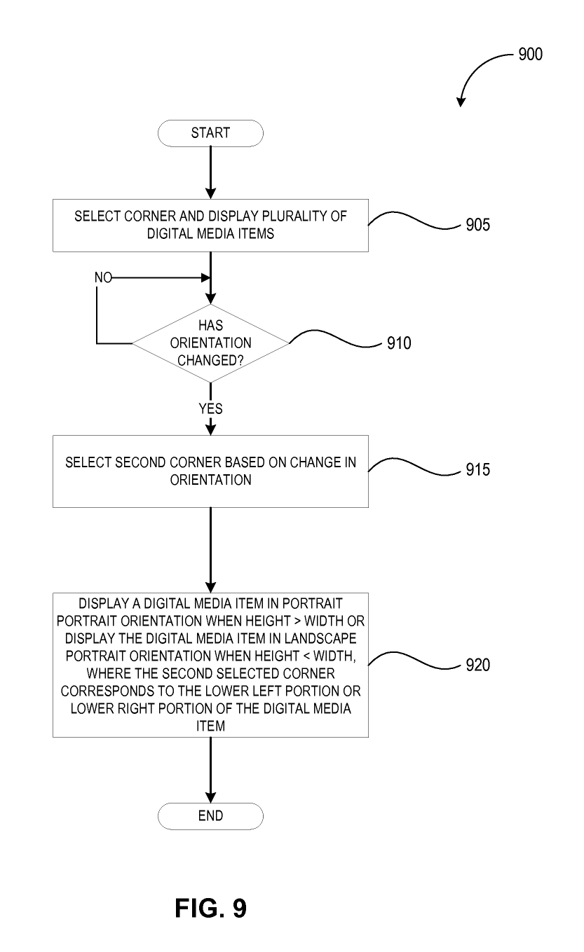

FIGS. 8 and 9 are flow diagrams illustrating methods for displaying digital media items. The methods may be performed by processing logic that may comprise hardware (circuitry, dedicated logic, etc.), software (such as is run on a general purpose computer system or a dedicated machine), or a combination of both. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media. In one embodiment, the method is performed by a client machine (e.g., an orientation detection module or a media viewing module).

FIG. 8 is a flow diagram illustrating a method 800 for displaying digital media items, in accordance with one embodiment. The method 800 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 800 is performed by a computing device (e.g., the computing device 300 of FIG. 3).

Referring to FIG. 8, the method 800 starts with the computing device detecting the orientation/position of the computing device at block 805. For example, the computing device may determine that the computing device is in a diagonal orientation (e.g., as shown in FIG. 4). At block 810, the computing device selects a corner based on the orientation of the computing device (e.g., selects corner 415 shown in FIG. 4). As discussed above, the selected corner may be the corner of the computing device which is closes to the user and/or pointed towards the user. After selecting a corner, the computing devices determines the height and width for each digital media item in a plurality of digital media items (block 815). In one embodiment, the computing device may determine the height and width for the plurality of digital media items prior to displaying any of the digital media items. In another embodiment, the computing device may determine the height and width of a particular digital media item prior to displaying the particular digital media item.

At block 820, the computing device displays the digital media item in a portrait orientation (e.g., as if the computing device was in a portrait orientation) when the height of the digital media item is greater than the width of the digital media item (e.g., as shown in FIG. 4). Also at block 820, the computing device displays the digital media item in a landscape orientation (e.g., as if the computing device was in a portrait orientation) when the height of the digital media item is less than the width of the digital media item (e.g., as shown in FIG. 4). The selected corner of the device corresponds to the lower left or lower right corner/portion of the digital media item. For example, as shown in FIG. 4, the lower left corner/portion 420 of the digital media item 410 corresponds to corner 415 of the computing device 400. In another example, as shown in FIG. 5, the lower right corner/portion 520 of the digital media item 410 corresponds to corner 515 of the computing device 500.

FIG. 9 is a flow diagram illustrating a method for displaying digital media items, in accordance with another embodiment. The method 900 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 900 is performed by a computing device (e.g., the computing device 300 of FIG. 3). In one embodiment, the method of 900 may be performed after the method 800 of FIG. 8 has been performed by the computing device.

Referring to FIG. 9, the method 900 starts with the computing device selecting a corner of the computing device and displaying a plurality of digital media items at block 905. At block 910, the computing device determines whether the orientation/position of the computing device has changed. If the orientation/position of the computing device has not changed, the method 900 proceeds back to block 910. If the orientation/position of the computing has changed, the computing device selects a second corner based on the change in position/orientation (block 915).

At block 920, the computing device displays the digital media item in a portrait orientation (e.g., as if the computing device was in a portrait orientation) when the height of the digital media item is greater than the width of the digital media item (e.g., as shown in FIG. 4). Also at block 920, the computing device displays the digital media item in a landscape orientation (e.g., as if the computing device was in a portrait orientation) when the height of the digital media item is less than the width of the digital media item (e.g., as shown in FIG. 4). The second corner of the device corresponds to the lower left or lower right corner/portion of the digital media item. For example, as shown in FIG. 4, the lower left corner/portion 420 of the digital media item 410 corresponds to corner 415 of the computing device 400. In another example, as shown in FIG. 5, the lower right corner/portion 520 of the digital media item 410 corresponds to corner 515 of the computing device 500.

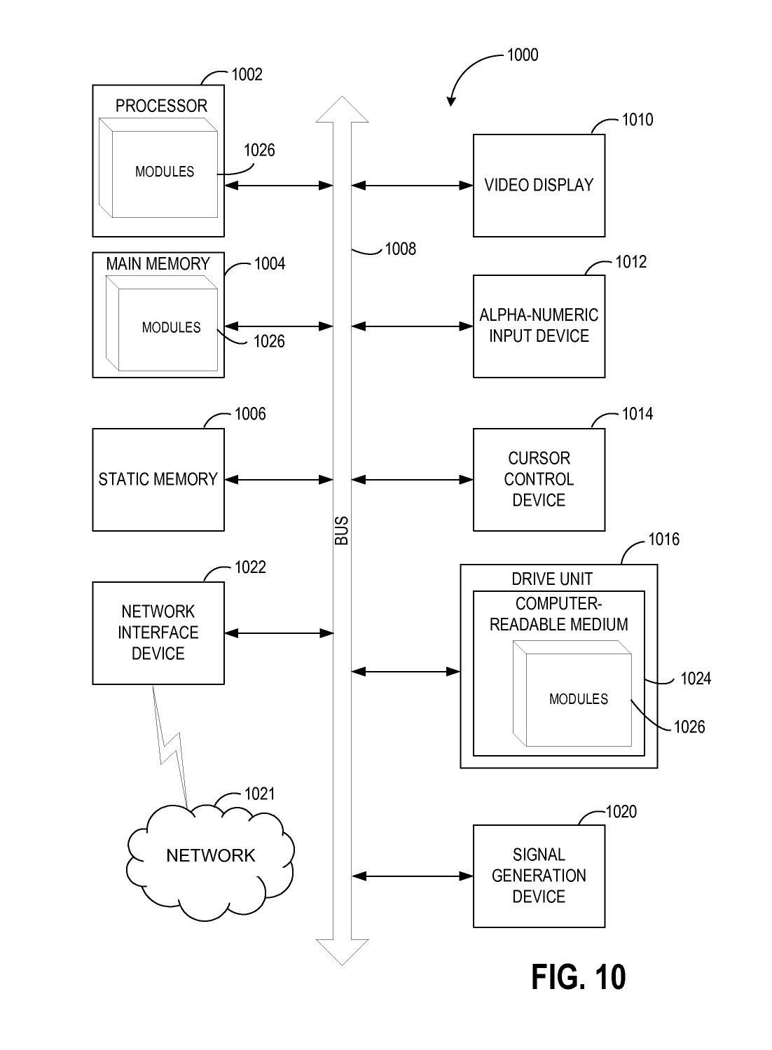

FIG. 10 illustrates a diagrammatic representation of a machine in the exemplary form of a computer system (e.g., a computing device) 1000 within which a set of instructions 1026, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a smart phone, a tablet computer, a touch screen computer, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 1000 includes a processor 1002, a main memory 1004 (e.g., read-only memory (ROM), flash memory, dynamic random access memory (DRAM) such as synchronous DRAM (SDRAM), etc.), a static memory 1006 (e.g., flash memory, static random access memory (SRAM), etc.), and a secondary memory 1016 (e.g., a data storage device or a drive unit), which communicate with each other via a bus 1008.

The processor 1002 represents one or more general-purpose processing devices such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processor 1002 may also be one or more special-purpose processing devices such as an application specific integrated circuit (ASIC), a field programmable gate array (FPGA), a digital signal processor (DSP), network processor, or the like. The processor 1002 is configured to execute any of the modules shown in FIG. 3 (e.g., the orientation detection module 305, the media viewing module 310, etc.) for performing the operations and steps discussed herein.

The computer system 1000 may further include a network interface device 1022. The network interface device may be in communication with a network 1021. The computer system 1000 also may include a video display unit 1010 (e.g., a liquid crystal display (LCD), a touch screen, or a cathode ray tube (CRT)), an alphanumeric input device 1012 (e.g., a keyboard, a touch screen, etc.), a cursor control device 1014 (e.g., a mouse, a touch screen, etc.), and a signal generation device 1020 (e.g., a speaker).

The secondary memory (e.g., drive unit) 1016 may include a computer-readable storage medium (or more specifically a non-transitory computer-readable storage medium) 1024 on which is stored one or more sets of instructions 1026 for modules embodying any one or more of the methodologies or functions described herein. The instructions 1026 of the modules may also reside, completely or at least partially, within the main memory 1004 and/or within the processing device 1002 during execution thereof by the computer system 1000, the main memory 1004 and the processing device 1002 also constituting computer-readable storage media. The instructions 1026 of the modules may further be transmitted or received over a network via the network interface device 1022.

While the computer-readable storage medium 1024 is shown in an exemplary embodiment to be a single medium, the term “computer-readable storage medium” should be taken to include a single medium or multiple media (e.g., a centralized or distributed database, and/or associated caches and servers) that store the one or more sets of instructions 1026. The term “computer-readable storage medium” shall also be taken to include any medium that is capable of storing or encoding a set of instructions for execution by the machine that cause the machine to perform any one or more of the methodologies of the present invention. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “detecting,” “identifying,” “selecting,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A method comprising:
detecting an orientation of a computing device;
selecting a corner of the computing device based on the orientation of the computing device; and
displaying a plurality of digital media items by:
determining a height and a width for each digital media item in a plurality of digital media items;
displaying, by a processing device, a first digital media item of the plurality of digital media items in a portrait orientation when the height of the first digital media item is greater than the width of the first digital media item, wherein a lower left portion of the displayed first digital media item or a lower right portion of the displayed first digital media item corresponds to the corner of the computing device; and
displaying a second digital media item of the plurality of digital media items in a landscape orientation when the width of the second digital media item is greater than the height of the second digital media item, wherein a lower left portion of the second digital media item or a lower right portion of the second digital media item corresponds to the corner of the computing device.

2. The method of claim 1, wherein the plurality of digital media items comprise images.

3. The method of claim 1, wherein the plurality of digital media items comprise videos.

4. The method of claim 1, wherein the corner comprises a lower left corner of the computing device.

5. The method of claim 1, wherein the corner comprises a lower right corner of the computing device.

6. The method of claim 1, further comprising:
detecting a change in the orientation of the computing device;
selecting a second corner of the computing device based on the change in the orientation of the computing device;
displaying a third digital media item of the plurality of digital media items in a portrait orientation when the height of the third digital media item is greater than the width of the third digital media item, wherein a lower left portion of the displayed third digital media item or a lower right portion of the displayed third digital media item corresponds to the second corner of the computing device; and
displaying a fourth digital media item of the plurality of digital media items in a landscape orientation when the width of the fourth digital media item is greater than the height of the fourth digital media item, wherein a lower left portion of the fourth digital media item or a lower right portion of the fourth digital media item corresponds to the second corner of the computing device.

7. The method of claim 1, wherein the corner comprises a closest corner to a user.

8. An apparatus comprising:
a processing device configured to:
detect an orientation of a computing device;
select a corner of the computing device based on the orientation of the computing device; and
display a plurality of digital media items by:
determining a height and a width for each digital media item in a plurality of digital media items;
displaying a first digital media item of the plurality of digital media items in a portrait orientation when the height of the first digital media item is greater than the width of the first digital media item, wherein a lower left portion of the displayed first digital media item or a lower right portion of the displayed first digital media item corresponds to the corner of the computing device; and
displaying a second digital media item of the plurality of digital media items in a landscape orientation when the width of the second digital media item is greater than the height of the second digital media item, wherein a lower left portion of the second digital media item or a lower right portion of the second digital media item corresponds to the corner of the computing device.

9. The apparatus of claim 8, wherein the plurality of digital media items comprise images.

10. The apparatus of claim 8, wherein the plurality of digital media items comprise videos.

11. The apparatus of claim 8, wherein the corner comprises a lower left corner of the computing device.

12. The apparatus of claim 8, wherein the corner comprises a lower right corner of the computing device.

13. The apparatus of claim 8, wherein the processing devices is further configured to:
detect a change in the orientation of the computing device;
select a second corner of the computing device based on the change in the orientation of the computing device;
display a third digital media item of the plurality of digital media items in a portrait orientation when the height of the third digital media item is greater than the width of the third digital media item, wherein a lower left portion of the displayed third digital media item or a lower right portion of the displayed third digital media item corresponds to the second corner of the computing device; and
display a fourth digital media item of the plurality of digital media items in a landscape orientation when the width of the fourth digital media item is greater than the height of the fourth digital media item, wherein a lower left portion of the fourth digital media item or a lower right portion of the fourth digital media item corresponds to the second corner of the computing device.

14. The apparatus of claim 8, wherein the corner comprises a closest corner to a user.

15. A non-transitory machine-accessible storage medium comprising data that when accessed by a processing device, cause the processing device to perform a method comprising:
detecting an orientation of a computing device;
selecting a corner of the computing device based on the orientation of the computing device; and
displaying, by the processing device, a plurality of digital media items by:
determining a height and a width for each digital media item in a plurality of digital media items;
displaying a first digital media item of the plurality of digital media items in a portrait orientation when the height of the first digital media item is greater than the width of the first digital media item, wherein a lower left portion of the displayed first digital media item or a lower right portion of the displayed first digital media item corresponds to the corner of the computing device; and
displaying a second digital media item of the plurality of digital media items in a landscape orientation when the width of the second digital media item is greater than the height of the second digital media item, wherein a lower left portion of the second digital media item or a lower right portion of the second digital media item corresponds to the corner of the computing device.

16. The non-transitory machine-accessible storage medium of claim 15, wherein the plurality of digital media items comprises one or more of images or videos.

17. The non-transitory machine-accessible storage medium of claim 15, wherein the corner comprises a lower left corner of the computing device.

18. The non-transitory machine-accessible storage medium of claim 15, wherein the corner comprises a lower right corner of the computing device.

19. The non-transitory machine-accessible storage medium of claim 15, wherein the method further comprises:
detecting a change in the orientation of the computing device;
selecting a second corner of the computing device based on the change in the orientation of the computing device;
displaying a third digital media item of the plurality of digital media items in a portrait orientation when the height of the third digital media item is greater than the width of the third digital media item, wherein a lower left portion of the displayed third digital media item or a lower right portion of the displayed third digital media item corresponds to the second corner of the computing device; and
displaying a fourth digital media item of the plurality of digital media items in a landscape orientation when the width of the fourth digital media item is greater than the height of the fourth digital media item, wherein a lower left portion of the fourth digital media item or a lower right portion of the fourth digital media item corresponds to the second corner of the computing device.

20. The non-transitory machine-accessible storage medium of claim 15, wherein the corner comprises a closest corner to a user.
